(19) United States
(12) Patent Application Publication
(10) Pub. No.: US 2007/0143456 A1
(43) Pub. Date: Jun. 21, 2007

(54) Exchange of centralized control data

(76) Inventor: Alex Mashinsky, New York, NY (US)

Correspondence Address: COHEN, PONTANI, LIEBERMAN & PAVANE, 551 FIFTH AVENUE, SUITE 1210, NEW YORK, NY, 10176, US

(21) Appl. No.: 10/581,952

(22) PCT Filed: Dec. 9, 2004
(86) PCT No.: PCT/US04/41143

§ 371 Date: Oct. 23, 2006

Related U.S. Application Data
(60) Provisional application No. 60/528,594, filed on Dec. 10, 2003.

(51) Int. Cl. G06F 15/173

(52) U.S. Cl. 709/223

(57) ABSTRACT

Apparatus and method (FIG. 2) for providing a user with unit as a gateway for communicating with home or office devices (252), as well as software developers, embed a second wired (240) or RF interface (270) in each device. This second interface, which supports standard protocols and user interface (UI) technology (245), such as tcp/ip, xml, html, Java and web browsers, is managed by the DCS unit (340) or by a mobile device (252) that integrates the DCS (340) technology.

### RELATED APPLICATIONS

This application claims priority from U.S. Provisional Patent Application Ser. No. 60/528,594 which was filed on Dec. 10, 2003.

### BACKGROUND OF THE INVENTION

1. Field of the Invention

The present invention generally relates to the field of remote accessing and, more particularly to an apparatus and method for utilizing a Data Collection Service (DCS) unit as a gateway for communicating with home or office devices and the Internet, on one side, and ordinary home an office equipment with display devices (DD), on the other.

2. Description of the Related Art

With the wide adoption of the WiFi, Bluetooth and UWB standards and the rapid decline of the cost of the chipsets needed to support these standards, a flood of next generation equipment and devices in the residential and commercial markets is expected within the next few years. Such devices typically posses their own user interface, operating systems and manual and remote control, and provide a different user interface and menu option for each device. By combining and standardizing the user interfaces for all such devices into a common interface format resembling a web browser or web services based exchange, which most users are already familiar with, a great deal of the complexity and the need for detailed, often confusing integration and programming can be eliminated.

To date several attempts have been made to create a universal remote control device by using different types of infrared and radio frequency (RF) transceivers. Such solutions, however, simply replace one proprietary user interface (UI) with another, and typically result in preventing access to many of the features in the original UI for the particular device. Some solutions even permit the connection of a TV or a computer to the universal remote control device. However, proprietary interfaces and corresponding menus are still utilized.

A personal digital assistant (PDA) is one potential candidate for use as a universal remote control device. An existing problem with PDA's and cell phones is that consumers prefer them to be as small and light-weight as possible, which eliminates the ability to display menus rich in data that provide access to information in a usable and interactive way. Such devices also limit user interface capabilities because the devices do not utilize mouse and keyboard peripherals.

In general, special purpose or custom-built equipment includes a relatively small display, such as a standard two line LCD display, with minimal functionality for displaying user interface menus. Because most of these consumer products are currently made and sold as stand alone items with proprietary RF remotes and display menus, it is practically impossible for a manufacturer to upgrade or make changes to the product software or feature set after the product is shipped from the manufacturer.

A growing problem exists with respect to monitoring patients at home and providing them with adequate health care. Even though many devices have been created to permit a patient to care for themselves, these devices need to be linked to monitoring centers to provide real time data to doctors or nurses who can immediately react to a patient whose condition begins to deteriorate.

Furthermore, with the increasing complexity involved with audio/video copyrights and rights of use, there is also a need for a system certified by the owners of the media to allow individual users to move files between their devices while maintaining compliance with copyright laws. Accordingly, there is a need to provide a user with a way to communicate with ordinary home or office devices and the Internet on one side and ordinary display devices on the other.

The life cycle of a consumer product has been shrinking for years and the average volume for each model has been decreasing. Many manufacturers are looking for ways to allow products to be shipped quickly and then extend their life cycle by providing the ability to add features or functionality at a later time. Since there is no centralized or internet based way to do this type of upgrading, only large manufacturers with substantial development budgets can compete in such a marketplace.

### SUMMARY OF THE INVENTION

The present invention is an apparatus and method for providing a user with the ability to utilize a Data Collection Service (DCS) as a gateway to communicate with mobile, home or office devices and the Internet or local LANs, on one side, and display devices, such as cell phones, hand held devices or computers, on the other. In accordance with the invention, manufacturers of home and office devices, as well as software developers, embed a second wired or RF interface in each device. This second interface, which supports standard protocols and user interface (UI) technology, such as tcp/ip, xml, html, Java and web services and browsers, is managed by the DCS or by mobile devices which integrate the DCS technology. In addition, the second interface provides single or multiple users with access to additional features and functions. In certain embodiments of the invention, the devices support Internet Protocol (IP) addressing. In alternative embodiments of the invention, the devices only support a proprietary communication via an external adapter, which permits communications with the DCS. The DCS can support both proprietary and standardized operating systems to enable communication and exchange of data wit the devices.

In accordance with the invention, the second interface also permits users to customize their home or office environment, track their profiles, activate or block features, change their menus and settings, as well as provide access to third parties for maintenance, upgrades or monitoring rights over standard WiFi, UWB and other RF or wired interfaces. In embodiments of the invention, the DCS is provided with hundreds of small programs that are downloaded from the Internet, and permit users to perform specific functions and interact with specific web services.

On the device side, the DCS supports both proprietary and standard sets of protocols, which provides a universal interface for use with any type of device. On the display side, the DCS enables customized viewing of selected devices, their status and optional controls and features, as well as manuals or support information. In accordance with invention, the information is displayable by the DCS and on more than one display at a time. As a result, easy access to all home devices from several locations is provided. In certain embodiments of the invention, the information is used by the DCS to scan the Internet for web services that offer new features, upgrades, services or improved monthly service plans. In addition, the DCS ensures that the available information represents the latest data from the manufactures and software providers by automatically checking authorized websites or server domains. In other embodiments of the invention, the DCS is located inside a mobile device or installed in a car, the home or the office, or is hosted in a remote environment. In the preferred embodiment, the DCS provide the data collection and display functions via a high-speed Internet link.

In accordance with the present invention, the DCS can be a standard PC or a proprietary computer running windows, Linux or another operating system, and may include a display unit. In accordance with the contemplated embodiments, the DCS is a portable computer with a touch screen or a wall mounted TV having an RF interface that accesses a WAN, LAN, or the Internet.

In the present invention, the protocols and interfaces supported by the DCS are standardized, and traditional HTML and Java as well as .NET capabilities may be utilized. As a result, a variety of manufacturers can dramatically reduce the cost of their consumer products and systems (e.g. phone systems, gadgets, appliances, etc.) and rely on the DCS units that are sold separately or installed on an owner's home computer or cable box to manage all of the products'features. In accordance with the invention, a household or a company may use a single DCS to manage hundreds of specialized devices. As a result, the costs associated with maintaining and extending the usefulness of the products is dramatically reduced.

In accordance with the invention, the ability to control multiple devices and systems from a user's DCS is provided. By simply clicking on an icon presented on the display screen of the DCS to initiate a session with such devices or systems, a menu of functions instantly appears. In certain embodiments of the invention, the functions that appear are a collection of jobs from different devices, calls to return based on receiving caller ID info, from a web or home based device, new features for installation, the occurrence of a security alarm breach on an Internet firewall, an alarm that a missing RFid that was attached to documents and was restricted to a specific room, an indication that a pet feeding machine needs to be refilled, and the like. The session can also be linked to other people or services such as the police or emergency personnel, technical support or outsourced administration personnel, if necessary.

In an embodiment of the invention, the DCS initiates outbound communications via preset profiles to one or multiple individuals via email, instant messenger, telephone or RF upon the occurrence of preprogrammed or abnormal events. For example, the removal of a box containing a firearm from a specific room may trigger an alarm since the DSC cannot communicate with the specific Rfid. Such a message will cause the DCS to issue an alarm to one or multiple parties. In accordance with the present embodiment, the RF interface (RFid) message is also used to locate and keep track of inventory, the freshness of food products or battery life that are translated by the DCS into “action items” for subsequent action. In accordance with the present embodiment, the DCS provides this function by monitoring, authenticating and reporting such information if necessary. By linking such data to internal or external web services, a delivery call can be sent to grocers or flower shops for a new delivery.

The apparatus and method of the invention permits home and office consumer devices to share access and use of an external DCS unit, instead of, or in addition to, the standard two-line LCD display or remote control that the manufacturer provides with its products. The DCS unit also permits the extended use of a computer monitor or a TV. As a result, the functionality of the computer or TV is enhanced. The DCS can be used to invite other people to share a program the owner is watching and provide them access to the video or program. Games and other social activities can be managed and coordinated by the DSC with other third parties who may be local or external to the network.

In addition, manufacturers are able to reduce the development time required to bring products to market, as well as extend the life cycle of these products. This is accomplished by developing products that are DCS compatible. As a result, manufacturers are able to reduce software development times dramatically because they can ship a product with only the basic software features. The software is upgradable when the user registers the product by downloading software from the web or by interfacing with the DCS which, in turn, is in communication with the Internet and can instantly check with the manufacturer for the latest software patch or new features offered through an upgrade. As a result, the problems associated with upgrading software after it is shipped are eliminated, and manufacturers can provide high margin upgrades to commodity type consumer goods. The apparatus and method of the invention also reduce the rate of obsolescence for consumer products due to the ability to continually add functionality with new software, lost or broken remotes, lost manuals or incompatibility issues.

In addition, manufacturers are able to reduce the development time required to bring products to market, as well as extend the life cycle of these products. This is accomplished by developing products that are DCS compatible. As a result, manufacturers are able to reduce software development times dramatically because they can ship a product with only the basic software features. The software is upgradable when the user registers the product by downloading software from the web or by interfacing with the DCS which, in turn, is in communication with the Internet and can instantly check with the manufacturer for the latest software patch or new features offered through an upgrade. As a result, the problems associated with upgrading software after it is shipped are eliminated, and manufacturers can provide high margin upgrades to commodity type consumer goods. The apparatus and method of the invention also reduces the rate of obsolescence for consumer products due to lost or broken remotes, lost manuals or incompatibility issues.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The foregoing and other advantages and features of the invention will become more apparent from the detailed description of the preferred embodiments of the invention given below with reference to the accompanying drawings in which:

FIGS. 1 and 2 are schematic block diagrams illustrating an exemplary environment containing multiple devices for control by a DCS unit in accordance with the invention;

FIG. 3 is a schematic block diagram of the architectural components of a DCS unit in accordance with the invention;

FIG. 4 is a schematic block diagram illustrating the interaction of the DCS unit with multiple exemplary devices, the Internet, and display units D1-D3;

FIG. 5 is an exemplary illustration of a display menu of the DCS unit of FIG. 3.

### DETAILED DESCRIPTION OF THE PRESENTLY PREFERRED EMBODIMENTS

The present invention is an apparatus and method for providing a user with the ability to utilize a Data Collection Server (DCS) unit as a gateway to communicate with home or office devices and the Internet or local LANs, on one side, and display devices, such as cell phones, hand held devices or computers, on the other. In accordance with the invention, manufacturers of home and office devices, as well as software developers, embed a second wired or RF interface in each device. This second interface, which supports standard protocols and user interface (UI) technology, such as tcp/ip, xml, html, Java and web browsers, is managed by the DCS unit or by mobile devices integrating the DCS technology. In addition, the second interface provides single or multiple users with access to additional features and functions. In certain embodiments of the invention, the devices support Internet Protocol (IP) addressing. In alternative embodiments of the invention, the devices only support a proprietary communication via an external adapter which permits communications with the DCS unit.

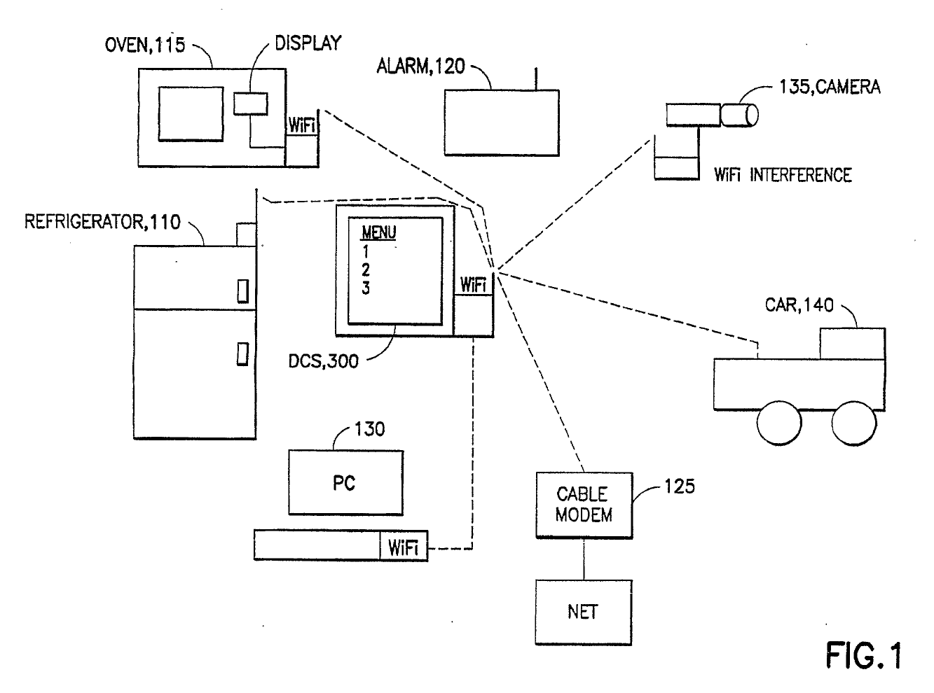

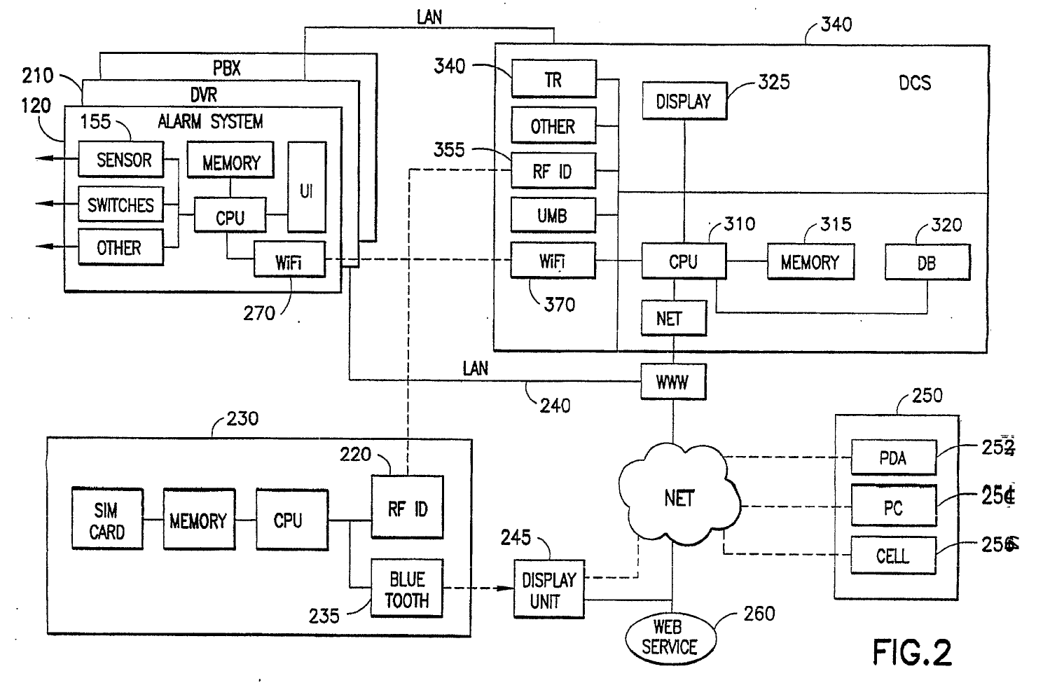

FIGS. 1 and 2 are schematic block diagrams illustrating an exemplary environment containing multiple devices for control by a DCS unit 300 in accordance with the invention. With reference to FIG. 1, there is shown an environment containing consumer electronic devices in a home or office, wherein multiple devices, such as DVR 210, refrigerator 110, oven 115, alarm 120, RFid 340, a private branch exchange (PBX) and corresponding phones 225, DSL/cable modem 125, PC 130, automobile 135, and camera 135, possess broadband network connectivity via wired or wireless technology. It should be noted that a person skilled in the art would appreciate that other electronic devices may be included in the environment, such as TVs, a VCR, audio equipment such as CD and DVD players, lighting systems, a cable box, toys and robots, AC Power, office equipment, windows, medical equipment and other electronic equipment, home and garden devices, and other home appliances, and the like.

With reference to FIGS. 1 and 2, a user may use a wireless authentication device 230, such as a cell phone, while at home to control the household devices. When the user is away from home, such as at work, he may use a PC to control the same household devices. In addition, a different menu with different personal settings for the same devices can be displayed upon authentication of the user. In accordance with the invention, when the user enters his home, the wireless authentication device 230 is triggered, and authentication by the DCS unit 300 is performed via RF interface (RFid) 220 or Bluetooth device 235 to automatically disable the home alarm system 120. In embodiments of the invention, the identification is also programmed to change the home settings to user preset options, such as to switch on a TV (not shown) and play the daily news program from the DVR 210. In certain embodiments of the invention, some devices are controlled via the RFid 220. In alternative embodiments, other devices are hard wired for control over a local area network (LAN) 240 that is connected to the World Wide Web.

In another embodiment of the invention, DCS unit 300 controls the setting of an automobile or some other mode of transportation, such as an airplane. When the user enters or approaches the automobile, the authentication device recognizes the automobile and adjusts settings based on the preferences of the authentication device user, such as the seat position, the steering wheel height, mirror angles, and/or the like. In alternative embodiments, the DCS unit is installed in the vehicle and performs the adjusting of the vehicle settings upon recognizing entry of the user possessing the authentication into the vehicle.

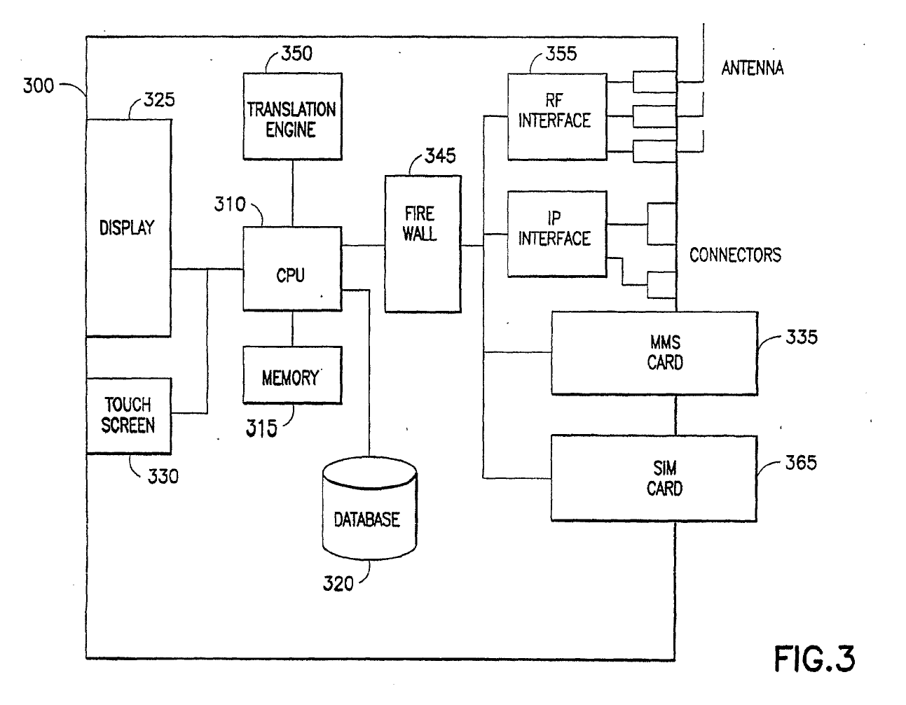

FIG. 3 is a schematic block diagram of the architectural components of a DCS unit 300. In accordance with the invention, DCS unit 300 is a computer. In the preferred embodiment, DCS unit 300 is a standard laptop computer, a mobile device with a built in hard drive or memory stick, a monitor having an optional touch screen 330, or an HDTV set with a thin client computer that functions as a medium to display an enhanced menu and user interface for all the home or office devices. With reference to FIG. 3, DCS unit 300 includes a CPU 310, memory 315, database 320, along with other optional components. In contemplated embodiments of the invention, the optional components are removable memory, such as a multimedia message service 335 (MMS) card or a SIM card 365 which may be inserted into a PC or mobile device.

In accordance with the present invention, the DCS unit may be local or remote to the devices, wired or wireless and may need a biometric, RFid 320 (see FIG. 2) or other type of digital identification prior to providing access to certain levels of service. In addition, the DCS unit 300 can support multiple RF interfaces 340 and multiple connectors to permit proprietary and standard interconnects. With additional reference to FIG. 3, DCS unit 300 may include a firewall for protecting all the devices and programs it maintains, as well as a translation engine 350 for converting data, communications from different RF devices, and/or data protocols that are used to transmit/receive data. In addition, the DCS unit 300 may be provided with a built in or external wireless hub 340 i.e. RF interface 340, attached to it that supports one or more of the display units 325. In accordance with the contemplated embodiments, the DCS unit 300 runs one or multiple OS systems. In addition, the DCS unit 300 may include an internal or external screen, with or without the touch screen 330. In accordance with the contemplated embodiments of the invention, the DCS unit functions as a universal remote control and obtains centralized status information of the consumer electronic devices and systems via the local WiFi interface, LAN 240, or the Internet.

In an exemplary implementation of the present invention, a traveler visiting a hotel or an airport requires access to devices in his home or office but needs to use a full screen display, mouse, and keyboard. By initiating a session via the public “kiosk” display unit 245 of FIG. 2, the DCS unit 300 in the user's home, for example, will sense a digital handshake from the authentication device 230, such as the user's cell phone or other RF tag device, and initiate a session that provides access via the Internet or create a session with the user's home or office devices or data.

The user may then redirect the DCS display information from display 325 (which may be in the user's home) to a display on the kiosk 245, and conduct his business. At the end of the transaction, the user may be billed for such an Internet access session by charging a fee to the credit card or phone account associated with the identifying device used to access the kiosk 245.

Alternatively, the DCS unit 300 is used in a mobile phone to control kiosk 245 and display a full screen information that is transmitted from the mobile device to the DCS.

Although next generation devices will be able to interact and transact with each other, this can only be accomplished upon performing complex setup routines for initiating and configuring such capabilities. As a result, in accordance with the present invention, instead of configuring each device individually, the DCS unit 300 translates the user settings to download specific configuration settings from the DCS unit 300 to a new wireless device. The DCS unit 300 provides continuous monitoring of all property in the home office, as well as other device activity. In addition, the DCS unit reports problems or activity as well as inactivity (e.g., a delivery was made, etc.) to a third party 250 such as personal digital assistant (PDA) 252, PC 254, or cell phone 256, based on settings or data provided from sensors 255 or PBX and phones devices 225.

In alternative embodiments of the present invention, the DCS unit 300 functions as an interface or “trusted party” for other technologies. For example, a DCS unit 300 may be registered in an external database 260 and electronically informed of larger numbers of changes or upgrades available for a large number of devices. In this case, without disclosing which devices it is managing, the DCS unit 300 screens the messages for only relevant active devices that are being managed by such DCS units. A decision is then made regarding whether such options need to be presented to the user via display 325, devices 250, or the like. In certain embodiments, the DCS unit 300 automatically updates programs or software if the identity or originator of the programs or software can be authenticated.

In accordance with the invention, different devices may use different forms of wireless technologies. As a result, the DCS unit 300 of the present invention is provided with the ability to function as a translator and the medium through which devices communicate or exchange transactions with each other or via RF interface 340, LAN 240, or the Internet 260. In an exemplary embodiment, DCS unit 300 interacts with infrared (IR) devices via IR interface 360 on one side and WiFi devices 270, 370 on the other. In another embodiment, DCS unit 300 also functions as a firewall or security gateway for all contemplated devices. If these devices are programmed to perform transactions only via the DCS unit 300, it will be easier to perform device authentication using the DCS unit than it would be to install separate and expensive authentication devices in each device.

In an alternative embodiment, a single wireless DCS unit 300 is used for managing transactions between multiple wirelessly enabled devices 225. For example, a user instructs the DCS unit 300 to download a file, such as a movie, from a .NET network via the Internet to the home PC (not shown), but then decides to move the downloaded file (e.g., the movie) to a car system (e.g., a video display system) for use. As a result, the DCS unit 300 will be required to handle the copyright envelope information to ensure the file rights associated with such a transfer. In another example, the automobile 140 of FIG. 1 reports the need for scheduled maintenance to the DCS unit 300, which is triggered to thereby provide instructions from internal database 320 or the Internet to address the problem or to send relevant information via the Internet to a service company to automatically schedule an appointment for maintenance.

In an additional embodiment, the DCS unit 300 is used to allow a user to place an order via the displayed menu of the DCS unit to switch home devices to a “night” mode. In accordance with the present embodiment, the command is programmed to have a predetermined delay, after which lights, air conditioning, other home or office devices, as well as the answering mode of the home and cell phones change their settings or deactivated entirely. In the preferred embodiment, the predetermined delay is 2 minutes or longer. In alternative embodiments, the predetermined delay is less than 2 minutes. It should be noted that even if the user activated an appliance, such as a TV, via an infrared remote, the occurrence of such a transaction would be communicated instantly to the DSC unit 300. As a result, the DCS unit will automatically know to deactivate the TV but continue to record any programs that are being recorded on the DVR 210.

In an additional embodiment of the invention, the DCS unit is used to connect to devices which permit a patient to care for themselves at home. In accordance with the present embodiment, the DCS unit aggregates data, manages the access and security requirements for permitting a third party to view the patient via cameras located in the home, as well as remotely control and manage medical equipment or administer treatment to the patient.

In another embodiment of the present invention, toy manufacturers may choose to provide owners of the toys with the ability to customize the movement, interaction and voice features, as well as physical programs on their toys. Although many toys come with remote control devices and prepossess RF capabilities, they cannot be customized by the users beyond the original setting of the manufacturer. In accordance with the present embodiment, a wireless connection to the DCS unit 300 is enabled to support the above-described remote administration. As a result, the users can manipulate, for example, a voice recording such that it plays back in the voice of the user. Alternatively, the user can cause programs to display specific data. In addition, the user may also ask the DCS unit to search the web for all new programs for their specific toy, and then click a button on any display unit 325 to decide what should be purchased and installed on the toy.

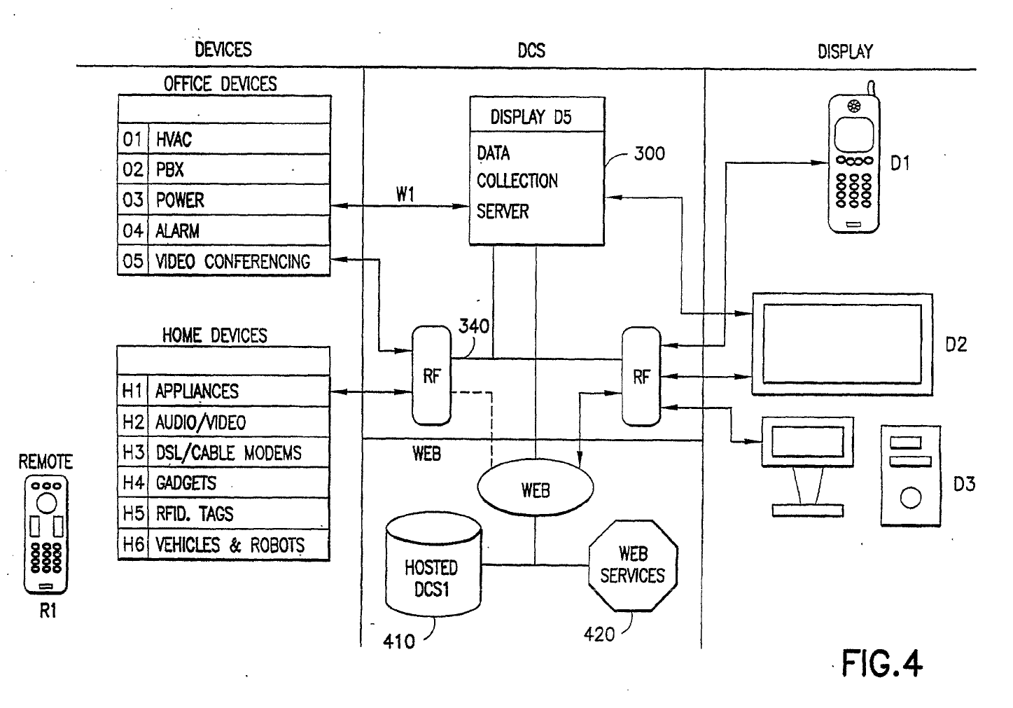

FIG. 4 is a schematic block diagram illustrating the interaction of the DCS unit 300 with multiple exemplary devices, the Internet, and display units D1-D3. As shown in FIG. 3, DCS unit 300 continuously collects information from devices H1-H6 and devices 01-05. This information is analyzed in DCS unit 300 and compared to internal custom settings that are provided by a manufacturer and the user. In accordance with the contemplated embodiments of the invention, the data is collected via wired interface W1 and RF interface 355 and may be processed locally, on a hosted service DCS1 410 or remotely by third parties via web services 420. The DCS also sends information to the device that is related to instructions originated via display units D1-D3, the Web, or other devices, as long as these instructions match internal security and profile settings of the DCS. With additional reference to FIG. 4, the exemplary devices are remotely manageable via a wired D2 or wireless interface D1. In accordance with the contemplated embodiments, the display may be combined with the display D5 in the DCS unit, or may be a separate display unit D2. DCS unit 300 maintains historical communications data with all registered devices, as well as historical settings and profiles provided by the user. In accordance with the contemplated embodiments, the DCS unit 300 can include a combination of proprietary and standard wireless or wired protocols. In addition, the DCS unit may use a local or hosted data collector that may be combined with or separated from the display unit.

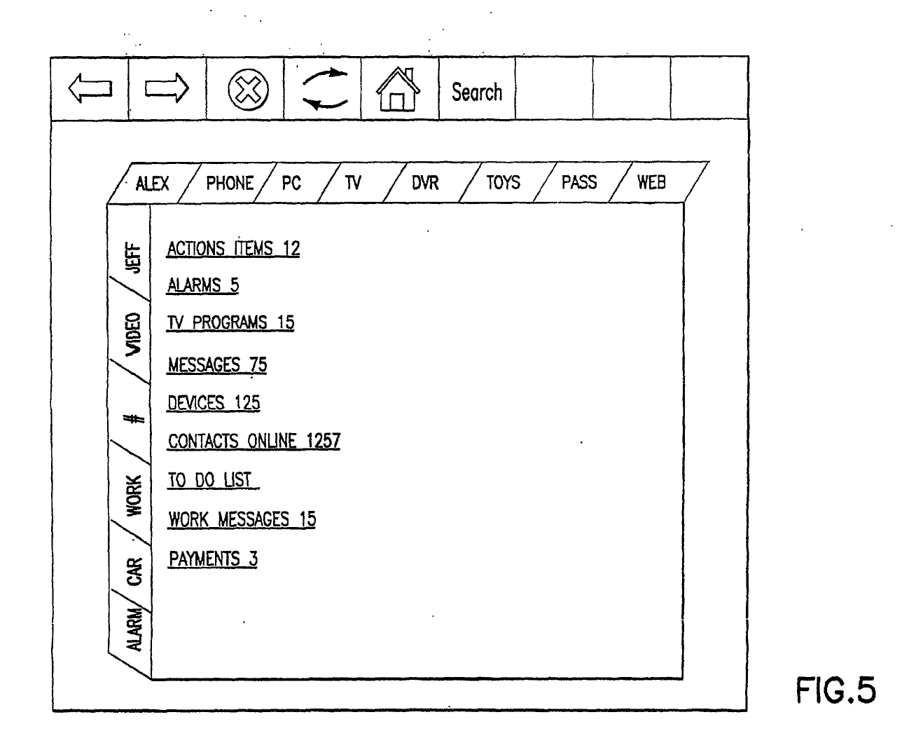

FIG. 5 is an exemplary illustration of a display menu of a DCS 300. With reference to FIG. 5, the display menu is based on a standard browser, which provides transparent navigation, search and command options for features and capabilities stored locally on the DCS unit, on the consumer devices or on the Internet. In accordance with the contemplated embodiments of the invention, the display menu permits different users to instantly switch profiles and change their environments, menus, files, and device inventory. The display menu is provided by the DCS unit 300 that collects up-to-date information from all local and remote items displayed on the user's menu. In the contemplated embodiments, the user may select specific tabs and customize the settings and system information related to each item. The user may also access any device by requesting files, programs, or services to be displayed or provided on the display device. Upon such a request, the DCS unit 300 will retrieve this information and reformat it for correct display on the screen.

Using the apparatus and method of the invention, home and office consumer devices are allowed to share access and use of an external DCS device, instead of, or in addition to, the standard two-line LCD display or remote control that the manufacturer provides with its products. Use of the apparatus and method of the invention also permits the extended use of a computer monitor or a TV. As a result, the functionality of the computer or TV is enhanced. In addition, manufacturers are able to reduce the development time required to bring products to market, as well as extend the life cycle of these products. This is accomplished by developing products that are DCS compatible. Manufacturers are then able to reduce software development times dramatically because they can ship a product with only the basic software features. The software is upgradable when the user registers the product by downloading software from the web or by interfacing with the DCS which, in turn, is in communication with the Internet and can instantly check with the manufacturer for the latest software patch or new features offered through an upgrade.

The apparatus and method of the invention eliminates the problems associated with upgrading software after it is shipped, and manufacturers are provides manufactures with the ability to provide high margin upgrades to commodity type consumer goods. In addition, the rate of obsolescence for consumer products due to lost or broken remotes, lost manuals or incompatibility issues is also reduced.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An apparatus for remotely controlling at least one electronic device having a communication interface in a local operating environment, comprising:
a processor;
a translation engine operatively coupled to the processor for converting at least one of data, communications from RF devices or data protocols for transmitting/receiving data to the at least one electronic device;
memory operatively coupled to the processor;
a database operatively coupled to the processor for storing centralized status data of the at least one electronic device; and
a display for providing an indication of the status of the at least one electronic device.

2. The apparatus as set forth in claim 1, further comprising:
a firewall operatively coupled to the processor for protecting the at least one electronic device from external access by unauthorized devices.

3. The apparatus set forth in claim 1, wherein the display includes a touch screen for inputting commands to the apparatus.

4. The apparatus of claim 1, further comprising:
an interface for receiving and transmitting commands from the apparatus to the communication interface of the at least one electronic device.

5. The apparatus of claim 1, further comprising at least one memory card.

6. The apparatus of claim 5, wherein the at least one memory card comprises at least one MMS card or at least one SIM card.

7. The apparatus of claim 1, wherein the apparatus is connected to a communication network.

8. The apparatus of claim 7, wherein the communication network is the Internet.

9. The apparatus of claim 1, wherein the apparatus is a data collection server.

10. The apparatus of claim 1, wherein the communication interface is a WiFi device.

11. The apparatus of claim 4, wherein the communication interface is a WiFi device.

12. The apparatus of claim 4, wherein the interface comprises at least an infrared interface, an RF interface, and a WiFi interface.

13. A system for remotely controlling at least one electronic device in a local operating environment, comprising:
a data collection device for forwarding commands over a network to the at least one electronic device;
a least one component interactively coupled to the system via an internal interface or a LAN which is connected to the network;
an external display unit connected to the network for remotely controlling the portable data collection device upon accessing the system;
an authentication device for providing remote access to the system; and
a third party device connected to the network for continuously monitoring the system.

14. The system of claim 13, wherein the portable data collection device comprises a processor; a translation engine operatively coupled to the processor for converting at least one of data, communications from RF devices or data protocols for transmitting/receiving data to the at least one electronic device; memory operatively coupled to the processor; a database operatively coupled to the processor for storing centralized status data of the at least one electronic device; and a display for providing an indication of the status of the at least one electronic device.

15. The system of claim 13, wherein the authentication device includes at least one of a SIM card, a Bluetooth interface or a RF interface.

16. The system of claim 15, wherein the authentication device accesses the data collection device via at least one of the Bluetooth interface or a RF interface to remotely access the system.

17. The system of claim 16, wherein upon accessing the data collection device via the Bluetooth interface a connection to the display unit occurs.

18. The system of claim 16, wherein the authentication device directly accesses the data collection device via the RF interface.

19. The system of claim 13, wherein the authentication device is a wireless device.

20. The system of claim 19, wherein the wireless device is a cell phone or a wireless enabled personal digital assistant.

21. The system of claim 13, wherein the network includes a .NET network connected to the Internet.

22. The system of claim 13, wherein the third party device is at least one of a personal digital assistant, a personal computer or a cell phone.

23. The system of claim 13, wherein the at least one electronic device is a home alarm system, a digital video recorder, a personal computer, a cable modem, a camera, a PBX system and corresponding phones, and home appliances.

24. The system of claim 23, wherein the home appliances are at least one of a refrigerator, or an oven.

25. The system of claim 13, wherein the internal interface is a WiFi device.

26. The system of claim 13, wherein the third party device is at least one of a personal digital assistant, a personal computer or a cell phone.

27. A method for remotely controlling at least one electronic device having a communication interface in a local operating environment, comprising:
forwarding at least one of data, communications from RF devices or data protocols for transmitting/receiving data to a translation engine operatively coupled to a processor;
converting the forwarded at least one of data, communications, data protocols in the translation engine;
storing centralized status data of the at least one electronic device in at least one of a memory and a database based on the converted data; and
providing a status indication of the at least one electronic device on a display of a data collection device based on the stored centralized data.

28. The method of claim 27, further comprising the step of:
protecting the at least one electronic device from external access by unauthorized devices via a firewall which is operatively coupled to the processor.

29. The method of claim 27, wherein the display includes a touch screen for inputting commands to the data collection device.

30. The method of claim 27, further comprising the step of:
receiving and transmitting commands from the data collection device to the communication interface of the at least one electronic device via an interface of the data collection device.

31. The method of claim 1, wherein said forwarding step comprises at least one of connecting the data collection device to a communications network or receiving data via the communication interface.

32. The method of claim 31, wherein the communication network is the Internet.

33. The method of claim 27, wherein the data collection device is a server.

34. The apparatus of claim 30, wherein the communication interface is a WiFi device.

35. The method of claim 31, wherein the communication interface is a WiFi device.

36. The method of claim 4, wherein the interface of the data collection device comprises at least an infrared interface, an RF interface, and a WiFi interface.

37. A method for remotely controlling electronic at least one electronic device in a local operating environment, comprising the steps of:
forwarding commands over a network from a data collection device to the at least one electronic device;
receiving the forwarded commands in at least one electronic device interactively coupled to the system via an internal interface or a LAN which is connected to the network;
controlling the data collection device upon accessing the system using an external display unit connected to the network;
remotely accessing the at least one device upon receiving authorization by an authentication device;
continuously monitoring the system via a third party device connected to the network.

38. The method of claim 37, wherein the data collection device comprises a processor; a translation engine operatively coupled to the processor for converting at least one of data, communications from RF devices or data protocols for transmitting/receiving data to the data collection device; memory operatively coupled to the processor; a database operatively coupled to the processor for storing centralized status data of the at least one device; and a display for providing an indication of the status of the at least one electronic device.

39. The method of claim 37, wherein the authentication device includes at least one of a SIM card, a Bluetooth interface or a RF interface.

40. The method of claim 39, wherein the authentication device accesses the data collection device via at least one of the Bluetooth interface or a RF interface to remotely access the system.

41. The method of claim 40, wherein upon accessing the data collection device via the Bluetooth interface a connection to the display unit occurs.

42. The method of claim 40, wherein the authentication device directly accesses the data collection device via the RF interface.

43. The method of claim 37, wherein the authentication device is a wireless device.

44. The method of claim 43, wherein the wireless device is a cell phone or a wireless enabled personal digital assistant.

45. The method of claim 37, wherein the third party device is at least one of a personal digital assistant, a personal computer or a cell phone.

46. The method of claim 37, wherein the at least one electronic device is a home alarm system, a digital video recorder, a personal computer, a cable modem, a camera, a PBX system and corresponding phones, and home appliances.

47. The method of claim 46, wherein the home appliances are at least one of a refrigerator, or an oven.

48. The method of claim 37, wherein the internal interface is a WiFi device.

49. The method of claim 37, wherein the third party device is at least one of a personal digital assistant, a personal computer or a cell phone.
